(19) United States
(12) Patent Application Publication
(10) Pub. No.: US 2014/0230400 A1
(43) Pub. Date: Aug. 21, 2014

(54) HEAT RETENTION AND DISTRIBUTION SYSTEM FOR GAS TURBINE ENGINES

(71) Applicants: KEVIN M. LIGHT, MAITLAND, FL (US); CHRISTOPHER W. ROSS, Oviedo, FL (US)

(72) Inventors: KEVIN M. LIGHT, MAITLAND, FL (US); CHRISTOPHER W. ROSS, Oviedo, FL (US)

(21) Appl. No.: 13/767,928

(22) Filed: Feb. 15, 2013

(51) Int. Cl. F02C 7/00

(52) U.S. Cl. CPC F02C 7/00
USPC 60/39.5

(57) ABSTRACT

A gas turbine engine including a compressor section, a combustor section, and a turbine section operating to produce a power output during a first mode of operation. A heat retention and distribution system is provided to the engine wherein the heat retention system operates in a second mode of operation, following a shutdown of the engine, to maintain an elevated temperature in components of each of the compressor section, the combustor section and the turbine section in order to effect (1) a reduction in an effective cyclic life consumption of the components and extend a maintenance interval associated with the effective cyclic life consumption, and (2) clearances by maintaining a higher vane carrier temperature with time during a non-power producing mode and more uniform temperature of most stationary components in the circumferential orientation.

### FIELD OF THE INVENTION

The present invention relates to gas turbine engines and, more particularly, to a system for retaining heat in a gas turbine engine following shutdown of the engine.

### BACKGROUND OF THE INVENTION

A gas turbine engine generally includes a compressor section, a combustor section, a turbine section and an exhaust section. In operation, the compressor section may induct ambient air and compress it. The compressed air from the compressor section enters one or more combustors in the combustor section. The compressed air is mixed with the fuel in the combustors, and the air-fuel mixture can be burned in the combustors to form a hot working gas. The hot working gas is routed to the turbine section where it is expanded through alternating rows of stationary airfoils and rotating airfoils and used to generate power that can drive a rotor. The expanded gas exiting the turbine section may then be exhausted from the engine via the exhaust section.

During operation of the engine, various components in the engine are subjected mechanical and thermal stresses that may reduce the mechanical integrity of the components over a period of engine operating time. The component life may be affected by both an overall operating time of the engine and by thermal cycling that can occur as a result of engine shutdown and subsequent engine starts. Hence, maintenance schedules are implemented to ensure that the engine is serviced to maintain a desired efficiency in the engine and to avoid component failures during operation of the engine.

### SUMMARY OF THE INVENTION

In accordance with an aspect of the invention, a gas turbine engine is provided comprising a compressor section where air pulled into a flow path of the engine is compressed, a combustor section where fuel is mixed with at least a portion of the compressed air and combusted to create hot combustion gases, a turbine section where the hot combustion gases from the combustor section are expanded in the flow path to extract energy therefrom during a first mode of operation, and an exhaust manifold downstream from the turbine section for receiving exhaust gases comprising expanded hot combustion gases from the turbine section. A heat retention system is provided wherein the heat retention system operates in a second mode of operation, following a shutdown of the engine, to maintain an elevated temperature in components of each of the compressor section, the combustor section and the turbine section in order to effect a reduction in an effective cyclic life consumption of the components and extend a maintenance interval associated with the effective cyclic life consumption.

The heat retention system may include structure recirculating air that has been warmed during passage of the air through the engine, the warmed air being recirculated from the exhaust manifold to an upstream location of the flow path during the second mode of operation.

The heat retention system may recirculate the warmed air in a continuous recirculation circuit that extends through the combustor and turbine sections to a location in the exhaust manifold where the warmed air is extracted from the flow path to enter the structure recirculating the warmed air to the upstream location.

The engine may further include plural air passages spaced circumferentially around the engine to form a plurality of recirculation circuits. The flow through each of the recirculation circuits may be individually controlled to provide different flows through the different recirculation circuits to equalize a temperature of the engine in the circumferential direction.

The structure recirculating the warmed air may be formed by a bleed air duct, the bleed air duct providing bleed air to the exhaust manifold from a bleed air cavity in the compressor during a third mode of operation prior to the first mode of operation.

The recirculating flow of warmed air may maintain a clearance between compressor blades and a surrounding vane carrier, and between compressor vanes and rotor, within the compressor section.

In accordance with another aspect of the invention a gas turbine engine is provided comprising a compressor section where air pulled into a flow path of the engine is compressed, the compressor having a compressor outer casing and a plurality of compressor bleed air openings formed through the compressor outer casing. A combustor section is provided where fuel is mixed with at least a portion of the compressed air from the compressor section and is combusted to create hot combustion gases. A turbine section is provided where the hot combustion gases from the combustor section are expanded to extract energy therefrom, wherein at least a portion of the extracted energy is used to rotate a turbine rotor during a first mode of operation. An exhaust manifold is located downstream from the turbine section, the exhaust manifold comprising a manifold casing for receiving exhaust gases comprising expanded hot combustion gases from the turbine section. A plurality of manifold openings are formed through the exhaust manifold casing, and a plurality of bleed air ducts extend from each of the compressor bleed air openings to each of the manifold openings for conveying bleed air from the compressor section to the manifold during a third mode of operation prior to the first mode of operation. An exhaust return section is associated with each of the bleed air ducts, each exhaust return section having an exhaust return section inlet and an exhaust return section outlet located on a respective bleed air duct between respective exhaust manifold and compressor bleed air openings. The exhaust return sections convey air that has been warmed during passage of the air through the engine, the warmed air being recirculated from the exhaust manifold to the compressor section through respective bleed air ducts during a second mode of operation comprising rotation of the turbine rotor following a shutdown of the engine ending the first mode of operation.

Valve structure may be provided in each of the bleed air ducts and the exhaust return sections for preventing flow of bleed air through the exhaust return section during the first and third modes of operation, and for preventing flow of air through a section of the bleed air duct between the exhaust return section inlet and outlet while permitting a flow of warmed air through the exhaust return section during the second mode of operation.

The valve structure permitting a flow of warmed air through the exhaust return section may include an exhaust valve, each exhaust valve having a plurality of partially open positions between a fully closed position and a fully open position, and including a controller connected to each exhaust valve for providing a differentially distributed flow of warmed air to different circumferential locations around the compressor section to effect a circumferentially equalized temperature in the compressor section.

The exhaust return sections may each include a blower for inducing flow of warmed air from the exhaust manifold to the compressor section during the second mode of operation.

The warmed air may be conveyed to a bleed air cavity located circumferentially around the compressor section and may be discharged from the bleed air cavity into the flow path of the engine to effect a warming of the combustor section and of the turbine section during the second mode of operation.

A maintenance interval for the engine may be defined by at least one parameter comprising a number of cold start cycles, each cold start cycle defined by starting the engine when one or more components are below a predetermined cold temperature for the component, and the warming of the combustor section and the turbine section, during the second mode of operation may effect an increase in the maintenance interval by maintaining a temperature for the one or more components located within the combustor section and turbine section above the predetermined cold temperature for the components for an extended period of time.

The second mode of operation may comprise a turning gear operation of the engine immediately following the first mode of operation of the engine to produce power.

The third mode of operation may comprise a startup operation of the engine at less than full power wherein air is bled from the bleed air cavity in the compressor section to the exhaust manifold to effect a reduction of pressure at a downstream location of the compressor.

In accordance with a further aspect of the invention, a gas turbine engine is provided comprising a compressor section where air pulled into a flow path of the engine is compressed, the compressor having a compressor outer casing, a compressor bleed air cavity formed between the outer casing and a compressor vane carrier, and a plurality of compressor bleed air openings formed through the compressor outer casing at the compressor bleed air cavity. A combustor section is provided where fuel is mixed with at least a portion of the compressed air from the compressor section and is combusted to create hot combustion gases. A turbine section is provided where the hot combustion gases from the combustor section are expanded to extract energy therefrom, wherein at least a portion of the extracted energy is used to rotate a turbine rotor during a first mode of operation. An exhaust manifold is located downstream from the turbine section, the exhaust manifold comprising a manifold casing for receiving exhaust gases comprising expanded hot combustion gases from the turbine section. A plurality of manifold openings are formed through the exhaust manifold casing, and a plurality of bleed air ducts extend from each of the compressor bleed air openings to each of the manifold openings for conveying bleed air from the compressor section to the manifold during a third mode of operation comprising an engine startup operation immediately preceding the first mode of operation. An exhaust return section is associated with each of the bleed air ducts, each exhaust return section having an exhaust return section inlet and an exhaust return section outlet located on a respective bleed air duct between respective manifold and compressor bleed air openings. The exhaust return sections convey air that has been warmed during passage of the air through the engine, the warmed air being recirculated from the exhaust manifold to the compressor section through respective bleed air ducts during a second mode of operation comprising rotation of the turbine rotor during a turning gear operation following a shutdown of the engine ending the first mode of operation.

A recirculating flow of warmed air supplied from the exhaust manifold may be conveyed from the compressor section to the combustor section and the turbine section during the second mode of operation.

A maintenance interval for the engine may be defined by at least one parameter comprising a number of cold start cycles, each cold start cycle defined by starting the engine when one or more components are below a predetermined cold temperature for the component, and the recirculating flow of warmed air to the combustor section and the turbine section may effect an increase in the maintenance interval by maintaining a temperature for the one or more components located within the combustor section and turbine section above the predetermined cold temperature for the components for an extended period of time.

The recirculating flow of the warmed air may reduce the thermal mechanical fatigue of the components in the combustor section and the turbine section.

The recirculating flow of the warmed air may maintain a clearance between compressor blades and a surrounding vane carrier within the compressor section.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a cross sectional view of a gas turbine engine illustrating aspects of the invention;

FIG. 2 is an enlarged cross sectional view of a portion of the compressor section shown in FIG. 1;

FIG. 3 is a graph illustrating a maintenance interval schedule for an engine utilized in different operations; and

FIG. 4 is a diagrammatic view illustrating aspects of the invention including control of plural circumferentially spaced air duct systems.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

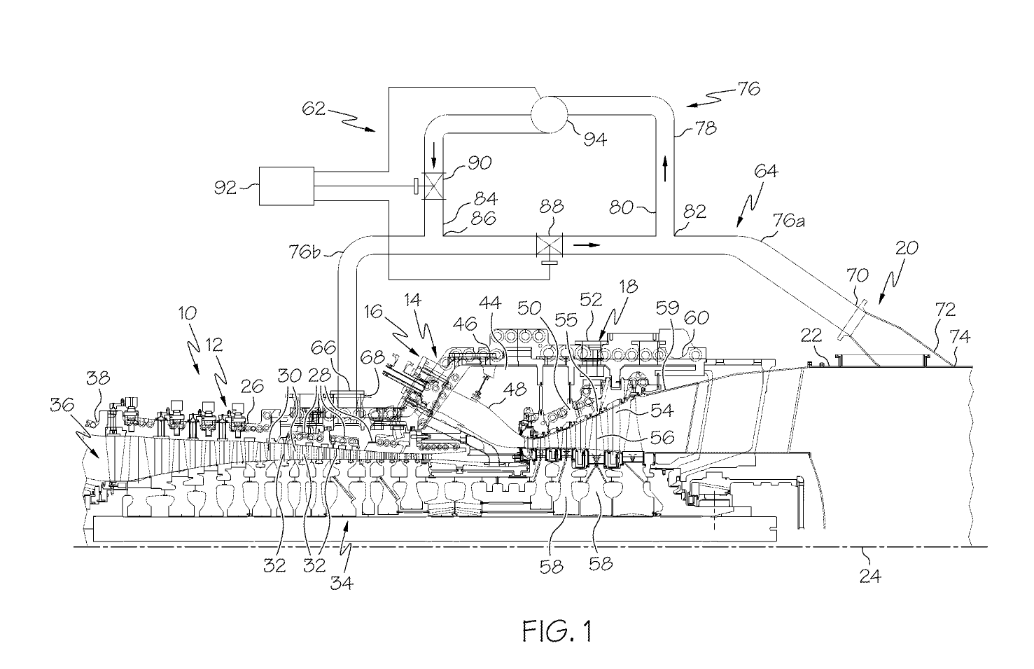

Referring to FIG. 1, a gas turbine engine 10 is shown illustrating aspects of the present invention. The engine includes a compressor section 12, a combustor section 14 including a plurality of combustors 16 (only one shown), and a turbine section 18. In addition, an exhaust manifold 20 comprising a manifold casing 22 is located downstream from the turbine section 18 for receiving expanded hot exhaust gases from the turbine section 18. It is noted that the engine 10 illustrated herein comprises an annular array of combustors 16 that are disposed about a longitudinal axis 24 of the engine 10 that defines an axial direction of the engine 10. Such a configuration is typically referred to as a “can-annular combustion system.”

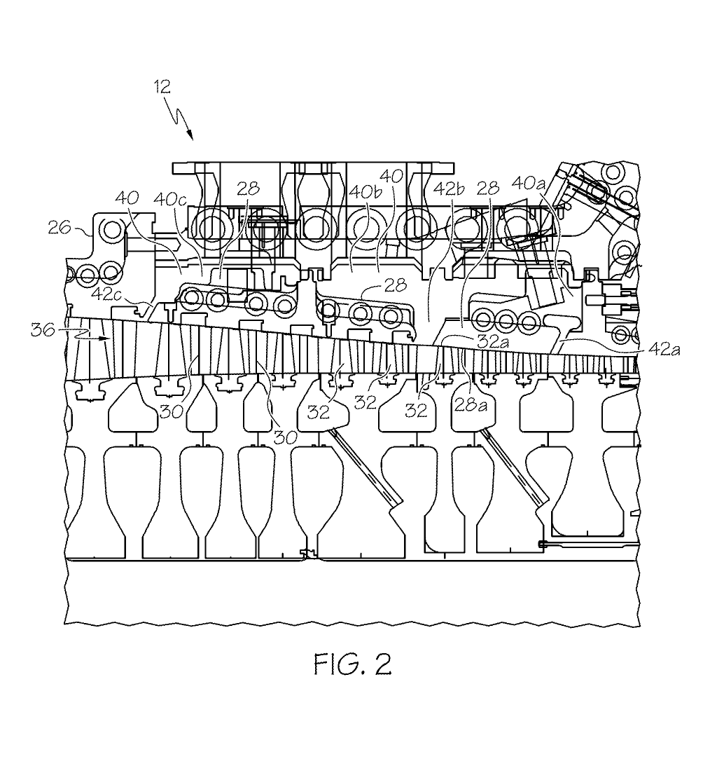

Referring additionally to FIG. 2, the compressor section 12 comprises an outer casing 26 enclosing various compressor components including vane carriers 28 supported from an interior structure of the outer casing 26, stationary vanes 30 supported from the vane carriers 28, and rotating blades 32 supported on a rotor assembly 34 and located in alternating relation to the vanes 30 to form compressor stages. The vanes 30 and blades 32 extend radially across a flow path 36 extending from an inlet 38 to the compressor section 12 to the exhaust manifold 20.

As is best seen in FIG. 2, the blades 32 include radially outer blade tips 32a that rotate in close proximity to inner surfaces 28a of the vane carriers 28. The inner surfaces 28a of the vane carriers 28 define a radially outer boundary for the flow path 36. Further, bleed air cavities 40 are defined between at least some of the vane carriers 28 and the outer casing 26, and comprise annular cavities extending circumferentially within the outer casing 26. In the illustrated embodiment, three bleed air cavities are particularly identified as 40a, 40b and 40c, and are located at axially downstream locations within the compressor section 12. Respective bleed air passages 42a, 42b and 42c connect the bleed air cavities 40a, 40b and 40c in fluid communication with the flow path 36. The bleed air passages 42a, 42b, 42c may be defined by radially extending gaps formed between adjacent vane carriers 28 for bleeding off a portion of the compressed air from the flow path 36 into the bleed air cavities 40a, 40b, 40c, as will be described further below.

Referring to FIG. 1, the combustor section 14 includes a combustor shell 44 defined within a combustor casing 46 that receives compressed air from the compressor section 12, referred to herein as “shell air”. The shell air passes into the individual combustors 16 for combustion with a fuel to produce hot combustion gases. The hot combustion gases are conveyed through a transition duct 48 associated with each combustor 46 to the turbine section 18.

The turbine section 18 includes vane carriers 50 supported within a turbine casing 52. Stationary turbine vanes 54 are supported on the vane carriers 50 and extend radially inward across the flow path 36. The vane carriers 50 additionally support ring segments 55 located in an axially alternating arrangement with outer endwalls of the vanes 54 to define an outer boundary of the flow path 36. Rotating turbine blades 56 are supported on respective turbine rotor disks 58 in an alternating arrangement with the vanes 54 to form stages of the turbine section 18. The rotating blades 56 extend radially outward across the flow path 36, and radially outer tips of the blades 56 are located adjacent to the ring segments 55. The hot combustion gases are expanded through the stages of the turbine section 18 to extract energy, and at least a portion of the extracted energy from the combustion gases causes the rotor 34 to rotate and produce a work output during a power producing mode of operation of the engine 10, referred to herein as a “first mode of operation”.

Subsequent to passing through the turbine section 18, the hot combustion gases, or exhaust gases, passing from the turbine section 18 enter a diffuser 59 located within a turbine exhaust casing 60 and then pass into the exhaust manifold 20.

In accordance with an aspect of the invention, an air duct system 62 is provided extending outside of the outer casing of the engine 10 between the compressor section 12 and the manifold section 20. The air duct system 62 includes one or more bleed air ducts extending from the compressor section 12 to an axially downstream location on the engine 10, as is illustrated in FIG. 1 by a bleed air duct 64. The bleed air duct 64 extends axially between a first end 66 connected to a bleed air port 68 extending through the compressor outer casing 26 and associated with the bleed air cavity 40b and second end 70 connected to a manifold port 72 associated with a manifold opening 74 in fluid communication with the flow path 36 in the manifold section 20.

The air duct system 62 additionally includes an exhaust return section 76 comprising an exhaust return duct 78 having an exhaust return section inlet 80 attached to the bleed air duct 64 at a first junction 82, and an exhaust return section outlet 84 attached to the bleed air duct 64 at a second junction 86. The exhaust return duct 78 is in fluid communication with the bleed air duct 64 at the first and second junctions 82, 86. The exhaust return section 76 further includes portions of the bleed air duct 64, including a first duct section 76a extending from the manifold port 72 to the first junction 82 and a second duct section 76b extending from the bleed air port 68 to the second junction 86. In accordance with an aspect of the invention, the exhaust return section 76 forms part of a heat retention system for the engine 10 to facilitate retention of heat and maintain an elevated temperature of components of the compressor section 12, the combustor section 14, and turbine section 18 during a non-power producing mode of operation of the engine 10, referred to herein as a “second mode of operation”, as will be described further below.

The air duct system 62 also includes a valve structure comprising a pair of flow control valves, including a first or bleed air valve 88 and a second or exhaust valve 90. The bleed air valve 88 is located in the bleed air duct 64 between the first and second junctions 82, 86. The exhaust valve 90 is located in the exhaust return duct 78 between the first and second junctions 82, 86. The valves 88, 90 are adjustable between fully open and fully closed positions, and preferably include a plurality of partially open positions between the fully open and fully closed positions, wherein the valves 88, 90 may be configured to provide a range of continuously variable partially open positions to control the amount of flow through the respective bleed air and exhaust return ducts 64, 78. The positions of the valves 88, 90 may be controlled by a controller 92, which may also comprise a controller for controlling other operations of the engine 10.

The exhaust return section 76 further includes a blower 94 located in the exhaust return duct 78 between the first and second junctions 82, 86, and configured to blow or induce flow of air through the exhaust return section 76 in a direction from the exhaust return section inlet 80 to the exhaust return section outlet 84. The blower 94 may be a variable speed blower and may be controlled by the controller 92 to provide a selected rate of air flow through the exhaust return section 76, from the exhaust manifold 20 to the compressor section 12, during the second mode of operation.

The bleed air duct 64 conveys bleed air from the compressor section 12 to the exhaust manifold 20 during a startup mode of operation of the engine at less than full power, referred to herein as a “third mode of operation”. In particular, during the third mode of operation, compressed air within the compressor section 12 is allowed to pass out of the flow path 36, through the bleed air passage 42b to the bleed air cavity 40b and into the air duct system 62 and exhaust manifold 20, such as to reduce the pressure in the downstream stages of the compressor section 12 and prevent stalling as the engine 10 comes up to speed during startup. The flow of bleed air through the air duct system 62 is controlled in the third mode of operation by closing the exhaust valve 90 and opening the bleed air valve 88 to a selected position to control the flow of bleed air to the exhaust manifold 20 where the bleed air mixes with the exhaust gases exiting the turbine section 18 in the flow path 36.

It should be understood that following startup of the engine 10, the bleed air valve 88 is moved to the closed position. In particular, following the startup or third mode of operation, when the engine 10 is in the first mode of operation to produce a power output from the engine 10, both the bleed air valve 88 and the exhaust valve 90 are closed to prevent flow of air and/or exhaust gases through the air duct system 62 during normal operation of the engine 10.

At the end of the first mode of operation, i.e., following a shutdown of the engine 10, such as may occur during a decrease in demand of a power grid supplied by the engine 10, the engine 10 is operated in the second mode of operation to retain heat within the engine 10 in order to maintain heat in the components of compressor section 12, combustor section 14, and turbine section 18. In particular, the second mode of operation comprises opening the exhaust valve 90 and activating the blower 94 immediately following the first mode of operation, while maintaining the bleed air valve 88 closed to provide a flow of warmed air through the exhaust return section 76 from the exhaust manifold 20 to the bleed air cavity 40b of the compressor section 12, which is also an element of the present heat retention system.

The second mode of operation further includes a turning gear operation where the rotor 34 is driven in operation by a motor, such as an electric motor, following shutdown of the engine 10 to provide a flow of air through the flow path 36 from the compressor inlet 38 to the exhaust manifold 20. As the air passes through the flow path 36, it is heated or warmed by various engine components which have a retained heat energy following the first mode of operation. In particular, following shutdown of the engine 10, the components of the combustor section 14 and/or turbine section 18 that have been exposed to the hot combustion gases may have a temperature of about 1200° C. to 1500° C. Normally, in a known engine construction, ambient air passing though the engine during turning gear operation is warmed and passes out of the engine, wherein the ambient air is supplied through the compressor inlet 38, and a continuous supply of the ambient air typically has provided cooling to the engine components.

In accordance with aspects of invention, at least a portion of the warmed air that has passed through the flow path 36 is recirculated from the exhaust manifold 20 to the bleed air cavity 40b and then passes through the bleed air passage 42b into the flow path 36 where it mixes with the ambient air flow entering from the compressor inlet 38. The warmed air passes through the final stages of the compressor section 12, downstream from the bleed air cavity 40b, enters the combustor shell 44, passes through the combustor 16 and transition duct 48 into the turbine section 18, and then into the exhaust manifold 20 in a continuous recirculating path. The recirculated warmed air absorbs additional heat as it passes through the combustor section 14 and turbine section 18 and, after being extracted from the exhaust manifold 20, is re-introduced through the bleed air cavity and passage 40b, 42b to add heat energy to the air flow within the flow path 36 and reduce the cooling effect of the air flow. As noted above, the described heat retention system effects a retention of heat within the components of the compressor section 12, the combustor section 14, and the turbine section 18, and reduces the thermal mechanical fatigue of these components.

To further describe the benefits of the present heat retention system, it may be understood that cyclical operation of the engine comprising heating of the engine components as a result of operation of the engine to produce power, including producing a flow of hot combustion gases, and a subsequent cooling operation following powered operation of the engine, results in a thermal mechanical fatigue of the individual components. This thermal mechanical fatigue results in an effective cyclic life consumption of the components, which affects the maintenance interval for the engine, along with the number of hours of engine operation.

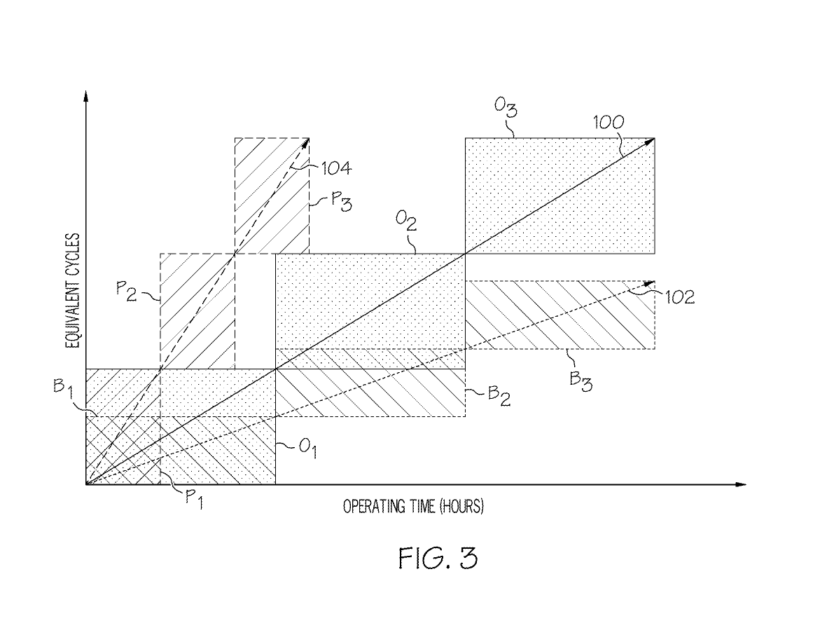

That is, in order to ensure that the engine 10 is inspected and/or has scheduled replacement of components to maintain a desired efficiency and to avoid a catastrophic failure of components, the engine 10 is operated and serviced in accordance with a schedule that provides for either a maximum number of operating hours or for a maximum number of “equivalent cycles”, as is illustrated, for example, by the service interval box O₁ in FIG. 3. In accordance with aspects of the invention, “equivalent cycles” may be a factor of actual cycles where the engine 10 is heated and cooled in cycles of powered operation (heating) and shutdown (cooling), or more typically may take into consideration particular temperature conditions that may be tracked by assigning “credits” to particular operating conditions. For example, a certain number of credits, e.g., two credits, may be assigned to a condition where the engine 10, or particular components within the engine 10, are cooled to a certain “warm” temperature above a predetermined temperature after engine shutdown, and providing a subsequent “warm” start of the engine; and a larger number of credits, e.g., four credits, may be assigned if the temperature in the engine drops to a “cool” temperature below the predetermined temperature, requiring a cold start of the engine. Since a cold start of the engine results in a higher amount of thermal mechanical fatigue on the engine components than a warm start of the engine, the larger number of credits reflect a higher level of cyclic life consumption for the components. The effective cyclic life on the vertical axis of the graph in FIG. 3 may reflect the added credits over a series of engine starts, where cold starts (higher credit values) will increase the frequency of the need for service or maintenance.

FIG. 3 illustrates service intervals for three types of engine usage in a “box service concept” format. The service box O₁ noted above is associated with line 100 depicting an engine operating at an optimum, or ideal, service level where the engine reaches a maximum number of service hours at the same time that it reaches the maximum effective cyclic life. Each of the subsequent boxes O₂ and O₃ depict further service intervals of the engine, where the lower left corner of each box corresponds to the start of a new service interval following a servicing of the engine. Hence, an engine operating along line 100 would optimize the number of effective starts of the engine for the number of available hours of operation.

Line 102 in FIG. 3 depicts an engine operating in a base load mode of operation which typically comprises a longer term of operation between starts. It may be noted that the slope of the line 102 is lower than the slope of line 100, corresponding to the reduced number of starts typical of base load operation, and the associated service boxes B₁, B₂, B₃ being shortened in the vertical direction. The operation of the base load engine reaches the limit for the maximum number of operating hours, i.e., the right-hand boundary of the service boxes B₁, B₂, B₃, prior to reaching the limit for the effective number of cycles. Hence, the service intervals will occur at the same number of hours as the engine operating at the optimum level of line 100, but will do so while providing fewer effective cycles during the interval.

Line 104 in FIG. 3 depicts an engine operating in a peaking mode of operation, where the engine is typically brought online and taken offline to provide peaking power during spikes in demand. Also typically, the cyclic consumption associated with a peaking engine is higher as a result of the higher number of starts required of the engine and the time span between starts being large, resulting in cold starts. This is reflect by line 104 having a steeper slope than lines 100 and 102, and the associated service boxes P₁, P₂, P₃ being elongated in the vertical direction. The operation of the engine in the peaking mode typically reaches the limit for equivalent cycles in the service interval, i.e., the upper boundary of the service boxes B₁, B₂, B₃, prior to reaching the limit for maximum hours of operation. In particular, it can be seen that, in comparison to the service interval associated with the engine operated in accordance with the optimum line 100, the peaking engine requires servicing approximately two and a half times more frequently, on an operating time basis.

In accordance with an aspect of the invention, the maintenance or service interval for an engine operated as a peaking engine can be improved, i.e., extended, by implementing the heat retention system, as provided by the air duct system 62 of the present invention. In particular, by providing the recirculating warm air to the hot components of the engine 10, the engine components may be maintained at an elevated temperature for a longer period of time. For example, the engine may be maintained at a temperature above 50% of steady-state temperature for an extended period of time. Hence, the temperature in the engine 10 may be maintained at a higher level during the time period spanning between an engine shutdown and a startup, resulting more of the starts of the engine being warm starts with reduced thermal mechanical fatigue to the components. As described above, warm starts acquire less cyclic consumption credits than cold starts, such that operation of the air duct system 62 to retain heat in the engine effectively reduces the slope of the peaking engine line 104, i.e., moves it toward the optimum line 100, to increase the maintenance or service interval.

In accordance with a further aspect of the invention, the provision of warmed air to the bleed air cavity 42b may facilitate maintaining a higher temperature for one or more of the vane carriers 28 to provide an active clearance control for the compressor blades 32 and stationary vanes 30. As noted above, the outer tips 32a of the compressor blades 32 rotate in close proximity to inner surfaces 28a of the vane carriers 28. Cooling of the vane carriers 28 following shutdown of the engine 10, where the cooling of the vane carriers 28 occurs at a greater rate than cooling of components associated with the rotor 34, could result in thermal movement and reduce the clearance and possibly result in wearing contact between the blades 32 and the carriers 28. Maintaining a higher vane carrier temperature can result in reduced thermal movement of the vane carriers 28, such that a greater clearance between the inner carrier surfaces 28a and the blade tips 32a is maintained to avoid or limit rubbing, with associated wear, between the blades 32 and carriers 28.

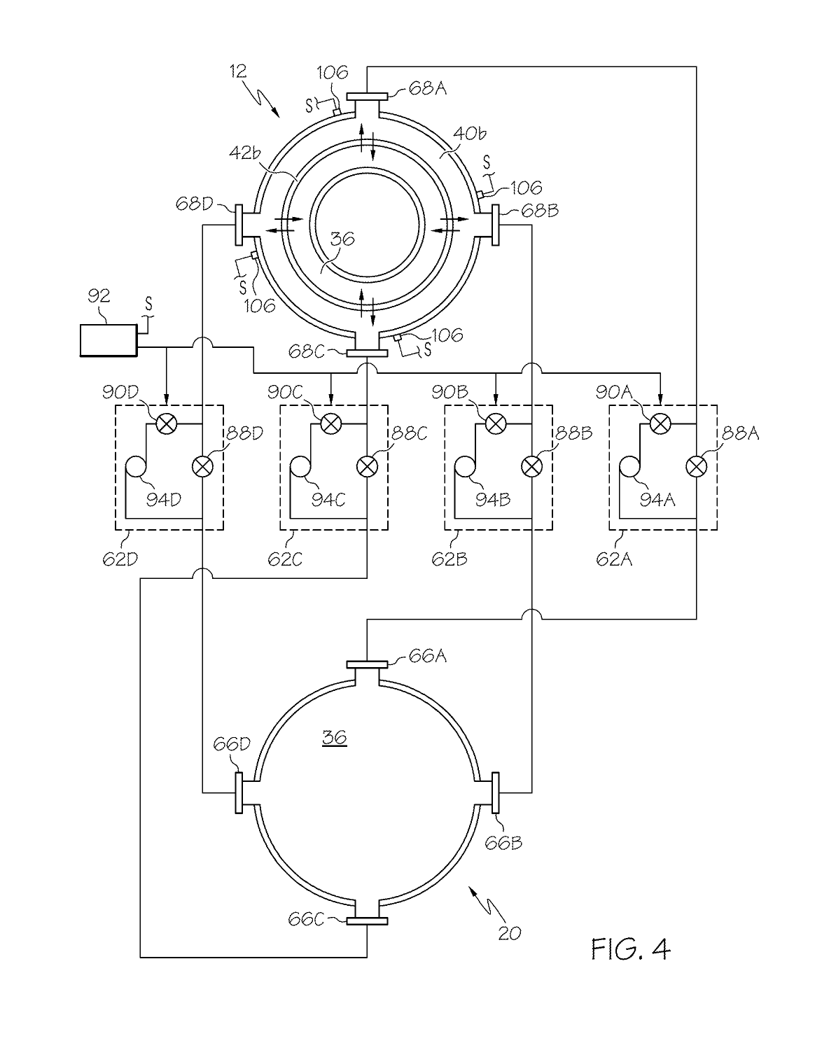

Referring to FIG. 4, an additional aspect of the invention is illustrated including plural air duct systems 62A-D wherein the air duct systems 62A-D include the same elements as the air duct system 62 extending between the compressor section 12 and the exhaust manifold 20, as illustrated in FIG. 1. The elements of each of the air duct systems 62A-D are labeled with the same reference numerals as for air duct system 62, including a letter suffix identifying the element with the respective air duct system 62A-D.

The air duct systems 62A-D are spaced circumferentially around the compressor section 12 and the exhaust manifold 20 to provide a circumferentially distributed flow of bleed air from the compressor section 12 in the third mode of operation and, in accordance with aspects of the present invention, to provide circumferentially controlled flows of warmed air from the exhaust manifold 20 to the bleed air cavity 40b in the second mode of operation. For example, it may be desirable to provide a differentially distributed flow of warmed air to different circumferential locations around the compressor section 12, such as to effect a circumferentially equalized temperature in the compressor section 12. In particular, since warm air within the engine 10 may tend to flow to the upper region of the engine 10, in certain circumstances it may be desirable to provide a greater flow of warmed air to the lower regions of the compressor section 12, e.g., via a greater flow through the air duct system 62C. Such a control of the warmed air could be used to maintain a substantially equal clearance between blade tips 32a and the inner carrier surfaces 28a around the circumference of the flow path 36 within the compressor section 12. Implementation of this control may be facilitated by providing sensors, such as circumferentially spaced sensors 106 connected to the controller 92, as depicted by broken line connections “S” in FIG. 4, to detect temperature differences between different circumferential locations around the compressor section 12.

Further, it may be desirable to provide a differentially distributed flow to different circumferential locations of the compressor section 12 to adjust for temperature differences in the combustor section 14 and turbine section 18, such as to avoid or limit ovalization of the engine casing that may occur at these locations. Ovalization may occur if, for example, the shell has a configuration that is partitioned in the circumferential direction, where the circumferential influence of temperatures in the combustor and turbine sections may be greater than a non-partitioned configuration. Control of the flow via the air duct systems 62A-D may be implemented in a manner similar to that described above, including provision of sensors at various locations for determining the circumferential temperature distribution on the engine.

The variation in flow through the air duct systems 62A-D can be provided through variably opening the respective exhaust valves 90A-D and/or through variably controlling the blowers 94A-D to induce more or less flow of warmed air through the air duct systems 62A-D.

It should be understood that, although four circumferentially distributed air duct systems 62A-D are described, any number of air duct systems may be provided for obtaining the benefits of the invention described herein. Further, although the recirculating flow of warmed air is shown and described as being associated with a particular compressor bleed air cavity 40b, such particular description is for illustrative purposes and other bleed air cavities may be utilized, and the warmed air may be conveyed to various other upstream locations if such locations provide flow access into the flow path 36. However, it may be noted that an aspect of the invention comprises utilizing existing bleed air ports and passages in the compressor section 12, as well as in the exhaust manifold 20, to minimize the cost of any modifications to implement aspects of the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A gas turbine engine comprising;
a compressor section where air pulled into a flow path of the engine is compressed;
a combustor section where fuel is mixed with at least a portion of the compressed air and combusted to create hot combustion gases;
a turbine section where the hot combustion gases from the combustor section are expanded in the flow path to extract energy therefrom during a first mode of operation;
an exhaust manifold downstream from the turbine section for receiving exhaust gases comprising expanded hot combustion gases from the turbine section; and
a heat retention system, the heat retention system operating in a second mode of operation, following a shutdown of the engine, to maintain an elevated temperature in components of each of the compressor section, the combustor section and the turbine section in order to effect a reduction in an effective cyclic life consumption of the components and extend a maintenance interval associated with the effective cyclic life consumption.

2. The gas turbine engine of claim 1, wherein the heat retention system includes structure recirculating air that has been warmed during passage of the air through the engine, the warmed air being recirculated from the exhaust manifold to an upstream location of the flow path during the second mode of operation.

3. The gas turbine engine of claim 2, wherein the heat retention system recirculates the warmed air in a continuous recirculation circuit that extends through the combustor and turbine sections to a location in the exhaust manifold where the warmed air is extracted from the flow path to enter the structure recirculating the warmed air to the upstream location.

4. The gas turbine engine of claim 3, including plural air passages spaced circumferentially around the engine to form a plurality of recirculation circuits.

5. The gas turbine engine of claim 4, wherein the flow through each of the recirculation circuits is individually controlled to provide different flows through the different recirculation circuits to equalize a temperature of the engine in the circumferential direction.

6. The gas turbine engine of claim 2, wherein the structure recirculating the warmed air is formed by a bleed air duct, the bleed air duct providing bleed air to the exhaust manifold from a bleed air cavity in the compressor during a third mode of operation prior to the first mode of operation.

7. The gas turbine engine of claim 2, wherein the recirculating flow of warmed air maintains a clearance between compressor blades and a surrounding vane carrier within the compressor section.

8. A gas turbine engine comprising:
a compressor section where air pulled into a flow path of the engine is compressed, the compressor having a compressor outer casing and a plurality of compressor bleed air openings formed through the compressor outer casing;
a combustor section where fuel is mixed with at least a portion of the compressed air from the compressor section and is combusted to create hot combustion gases;
a turbine section where the hot combustion gases from the combustor section are expanded to extract energy therefrom, wherein at least a portion of the extracted energy is used to rotate a turbine rotor during a first mode of operation;
an exhaust manifold downstream from the turbine section, the exhaust manifold comprising a manifold casing for receiving exhaust gases comprising expanded hot combustion gases from the turbine section;
a plurality of manifold openings formed through the manifold casing;
a plurality of bleed air ducts extending from each of the compressor bleed air openings to each of the manifold openings for conveying bleed air from the compressor section to the manifold during a third mode of operation prior to the first mode of operation;
an exhaust return section associated with each of the bleed air ducts, each exhaust return section having an exhaust return section inlet and an exhaust return section outlet located on a respective bleed air duct between respective manifold and compressor bleed air openings; and
the exhaust return sections conveying air that has been warmed during passage of the air through the engine, the warmed air being recirculated from the exhaust manifold to the compressor section through respective bleed air ducts during a second mode of operation comprising rotation of the turbine rotor following a shutdown of the engine ending the first mode of operation.

9. The gas turbine engine of claim 8, including valve structure in each of the bleed air ducts and the exhaust return sections for preventing flow of bleed air through the exhaust return section during the first and third modes of operation, and for preventing flow of air through a section of the bleed air duct between the exhaust return section inlet and outlet while permitting a flow of warmed air through the exhaust return section during the second mode of operation.

10. The gas turbine engine of claim 9, wherein the valve structure permitting a flow of warmed air through the exhaust return section includes an exhaust valve, each exhaust valve having a plurality of partially open positions between a fully closed position and a fully open position, and including a controller connected to each exhaust valve for providing a differentially distributed flow of warmed air to different circumferential locations around the compressor section to effect a circumferentially equalized temperature in the compressor section.

11. The gas turbine engine of claim 9, wherein the exhaust return sections each include a blower for inducing flow of warmed air from the exhaust manifold to the compressor section during the second mode of operation.

12. The gas turbine engine of claim 8, wherein the warmed air is conveyed to a bleed air cavity located circumferentially around the compressor section and is discharged from the bleed air cavity into the flow path of the engine to effect a warming of the combustor section and of the turbine section during the second mode of operation.

13. The gas turbine engine of claim 12, wherein a maintenance interval for the engine is defined by at least one parameter comprising a number of cold start cycles, each cold start cycle defined by starting the engine when one or more components are below a predetermined cold temperature for the component, and the warming of the combustor section and the turbine section, during the second mode of operation effects an increase in the maintenance interval by maintaining a temperature for the one or more components located within the combustor section and turbine section above the predetermined cold temperature for the components for an extended period of time.

14. The gas turbine engine of claim 13, wherein the second mode of operation comprises a turning gear operation of the engine immediately following the first mode of operation of the engine to produce power.

15. The gas turbine engine of claim 14, wherein the third mode of operation comprises a startup operation of the engine at less than full power wherein air is bled from the bleed air cavity in the compressor section to the exhaust manifold to effect a reduction of pressure at a downstream location of the compressor.

16. A gas turbine engine comprising:
a compressor section where air pulled into a flow path of the engine is compressed, the compressor having a compressor outer casing, a compressor bleed air cavity formed between the outer casing and a compressor vane carrier, and a plurality of compressor bleed air openings formed through the compressor outer casing at the compressor bleed air cavity;
a combustor section where fuel is mixed with at least a portion of the compressed air from the compressor section and is combusted to create hot combustion gases;
a turbine section where the hot combustion gases from the combustor section are expanded to extract energy therefrom, wherein at least a portion of the extracted energy is used to rotate a turbine rotor during a first mode of operation;
an exhaust manifold downstream from the turbine section, the exhaust manifold comprising a manifold casing for receiving exhaust gases comprising expanded hot combustion gases from the turbine section;
a plurality of manifold openings formed through the manifold casing;
a plurality of bleed air ducts extending from each of the compressor bleed air openings to each of the manifold openings for conveying bleed air from the compressor section to the manifold during a third mode of operation comprising an engine startup operation immediately preceding the first mode of operation;
an exhaust return section associated with each of the bleed air ducts, each exhaust return section having an exhaust return section inlet and an exhaust return section outlet located on a respective bleed air duct between respective manifold and compressor bleed air openings;
the exhaust return sections conveying air that has been warmed during passage of the air through the engine, the warmed air being recirculated from the exhaust manifold to the compressor section through respective bleed air ducts during a second mode of operation comprising rotation of the turbine rotor during a turning gear operation following a shutdown of the engine ending the first mode of operation.

17. The gas turbine engine of claim 16, wherein a recirculating flow of warmed air supplied from the exhaust manifold is conveyed from the compressor section to the combustor section and the turbine section during the second mode of operation.

18. The gas turbine engine of claim 17, wherein a maintenance interval for the engine is defined by at least one parameter comprising a number of cold start cycles, each cold start cycle defined by starting the engine when one or more components are below a predetermined cold temperature for the component, and the recirculating flow of warmed air to the combustor section and the turbine section effects an increase in the maintenance interval by maintaining a temperature for the one or more components located within the combustor section and turbine section above the predetermined cold temperature for the components for an extended period of time.

19. The gas turbine engine of claim 18, wherein the recirculating flow of the warmed air reduces the thermal mechanical fatigue of the components in the combustor section and the turbine section.

20. The gas turbine engine of claim 19, wherein the recirculating flow of the warmed air maintains a clearance between compressor blades and a surrounding vane carrier within the compressor section.
